(19) United States
(12) Patent Application Publication
(10) Pub. No.: US 2011/0318148 A1
(43) Pub. Date: Dec. 29, 2011

(54) CABLE REEVING SYSTEM FOR LIFTING AND LOADING

(76) Inventor: James H. Obermeyer, Crown Point, IN (US)

(21) Appl. No.: 12/821,393

(22) Filed: Jun. 23, 2010

(51) Int. Cl. B60P 1/00; B60P 1/04

(52) U.S. Cl. 414/469; 414/559

(57) ABSTRACT

A vehicle-mounted lift and cable reeving system attachable to a vehicle for loading, tilting and unloading containers is disclosed. A carriage assembly adapted to connect to the container is moved forward and rearward on a tilting frame by a cable reeving system. The cable reeving system includes a force actuator (e.g., hydraulic cylinder) that presses against the middle portion of a cable assembly attached to the frame and the carriage using, for example, pulleys. The cable assembly pulls the carriage assembly a greater distance than the force actuator travels and is capable of moving the carriage from the front to the rear of the frame. Other embodiments enhance stability during loading, unloading and dumping by including a rear hinge assembly that moves the rear end of the tilting frame downward to contact the support surface as the front end of the tilting frame is raised.

### FIELD

Embodiments of the present invention generally relate to loading objects onto vehicles, tilting objects loaded on the vehicles for dumping, and unloading the objects from vehicles.

### BACKGROUND

Trucks are frequently used to load, transport, unload, and sometimes dump containers holding various types of material. These trucks sometimes use lifts attached to the truck to load the containers onto the truck, hold the containers on the truck during transport, hold the containers while being tilted to dump the contents out of the containers, and offload the containers from the truck. For example, the waste and recycling industries frequently use lifts attached to trucks to transport and dump waste and recycling containers (one example being the Dumpster® brand trash receptacle). One type of lift, commonly referred to as a cable hoist, uses a winch to pull a cable the operator has connected to a container and draw the container onto the truck. Tow trucks (also referred to as wreckers) commonly use cable hoists and a tilting flat bed to onload and offload vehicles. Vehicle-mounted lifts are another type that use a rigid hook assembly to connect with the container to be onloaded, offloaded, and/or dumped. See, e.g., U.S. Patent Application Publication No. 2007/0092364 A1, published Apr. 26, 2007 to Geise et al.

### SUMMARY

Difficulties exist with current vehicle-mounted lifts for loading, unloading and dumping. For example, some vehicle-mounted lifts become unstable while onloading, offloading and/or dumping containers. Other vehicle-mounted lifts require the vehicle operator to exit the vehicle's cab during the loading, unloading and/or dumping process. Still other vehicle-mounted lifts use multi-stage hydraulic cylinders (those with multiple telescoping piston sections), which are more complicated, more prone to leaking, and more prone to break-down than single-stage hydraulic cylinders. Other vehicle-mounted lifts place high stress loadings at critical points in the system that can fail during loading and/or unloading, creating an unsafe situation. Still other vehicle-mounted lifts use cables but allow the cables to become slack, which frequently results in the cables misfeeding, binding and breaking.

Some vehicle-mounted lifts use a hydraulic cylinder and a ratcheting system to incrementally move the container onto the vehicle; however, these hoists are slow, may require the operator to command the hydraulic piston to the extended and retracted position numerous times to load a container, and have complicated ratcheting systems that require additional maintenance, use special/expensive containers with numerous ratchet connectors, and pose safety risks if the ratcheting system fails. Still other vehicle-mounted lifts use long cables wrapped around a number of pulleys; however, these lifts are complex and the large number of pulleys and the long length of the cable create excess play and/or bounce in these vehicle-mounted lifts.

One embodiment of the present invention includes a vehicle-mounted lift with a tiltable frame assembly that is connectable to a vehicle, such as a truck. One or more lift cylinders lift the forward end of the frame for loading containers, unloading containers, or dumping the contents of the containers while the containers remain on the tilted frame. A hook assembly is mounted to the frame assembly and travels along the length of the frame assembly. The hook assembly includes a hook that engages the container and pulls the container onto the frame.

The vehicle-mounted lift also includes a cable reeving system that moves, such as by pulling or drawing, the hook assembly along the length of the frame. The cable reeving system acts as a distance multiplier and uses the force generated by a hydraulic cylinder to move the hook assembly carriage a greater distance than the distance the end of the piston rod moves. The cable reeving system is capable of moving the hook assembly the full length of the frame and the full length of the extended hydraulic cylinder from the base of the piston to the tip of the fully-extended piston rod using a single-stage hydraulic cylinder despite the piston and piston rod each occupying a length along the frame that is considerably longer than the length along the frame the hook assembly occupies and considerably shorter than the distance along the frame the hook assembly travels. The cable reeving system also maintains the cables taut, which minimizes the misfeeding, binding and breaking of the cables.

Embodiments of the present invention provide an improved vehicle-mounted lift adapted to load, unload and dump a container.

Other embodiments of the present invention include a cable reeving system for loading, unloading and dumping containers.

Still other embodiments provide an improved vehicle-mounted lift with a rear hinge assembly that moves the rear end of the hoist frame downward and positions a stabilizer against the support surface to stabilize the vehicle during loading, unloading and dumping.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not intended to address every object described herein, and each embodiment does not necessarily include each feature described. Other forms, embodiments, objects, advantages, benefits, features, and aspects of the present invention will become apparent to one of skill in the art from the detailed description and drawings contained herein.

### BRIEF DESCRIPTION OF THE DRAWINGS

FIG. 1 is a perspective view of a vehicle with a vehicle-mounted lift and cable reeving system according to one embodiment of the present invention.

FIG. 2 is a bottom perspective view of the vehicle-mounted lift and cable reeving system depicted in FIG. 1.

FIG. 3 is a bottom perspective view of the vehicle-mounted lift and cable reeving system depicted in FIG. 2 with various components removed to provide a clearer view of the depicted components.

FIG. 4 is a bottom perspective view of the vehicle-mounted lift and cable reeving system depicted in FIG. 3 with additional components removed to provide a clearer view of the depicted components.

FIG. 5 is a bottom perspective view of the vehicle-mounted lift and cable reeving system depicted in FIG. 4 with the carriage assembly at a different location.

FIG. 6 is a bottom plan view of the vehicle-mounted lift and cable reeving system depicted in FIG. 4 with additional components removed to provide a clearer view of the depicted components.

FIG. 7 is a fragmentary, perspective view of the rear end portion of the vehicle-mounted lift and cable reeving system depicted in FIG. 1 mounted to the truck and with the rear end lowered.

FIG. 8 is a side elevational view of the vehicle-mounted lift and cable reeving system depicted in FIG. 1 and a container to be loaded onto the truck.

FIG. 9 is a side elevational view of the vehicle-mounted lift and cable reeving system depicted in FIG. 8 with the container located at a different location during loading.

FIG. 10 is a side elevational view of the vehicle-mounted lift and cable reeving system depicted in FIG. 8 with the container in the loaded position.

FIG. 11 is side perspective view of the vehicle-mounted lift and cable reeving system depicted in FIG. 10 holding the container in a dumping position.

### DETAILED DESCRIPTION OF THE ILLUSTRATED EMBODIMENTS

For the purposes of promoting an understanding of the principles of the invention, reference will now be made to the selected embodiments illustrated in the drawings and specific language will be used to describe the same. It will nevertheless be understood that no limitation of the scope of the invention is hereby intended, such alterations, modifications, and further applications of the principles of the invention being contemplated as would normally occur to one skilled in the art to which the invention relates. At least one embodiment of the invention is shown in great detail, although it will be apparent to those skilled in the relevant art that some features or some combinations of features may not be shown for the sake of clarity.

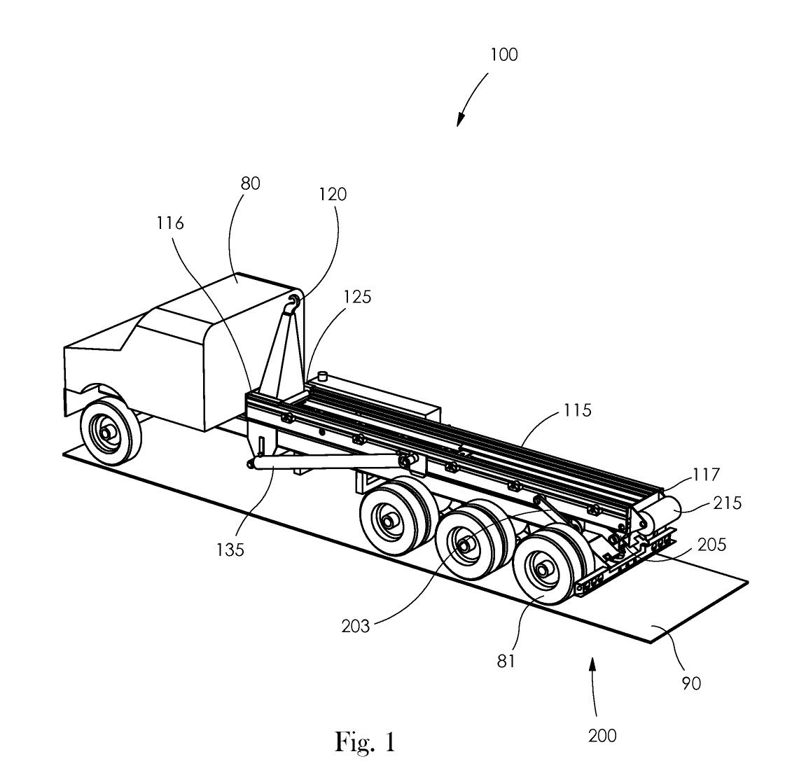

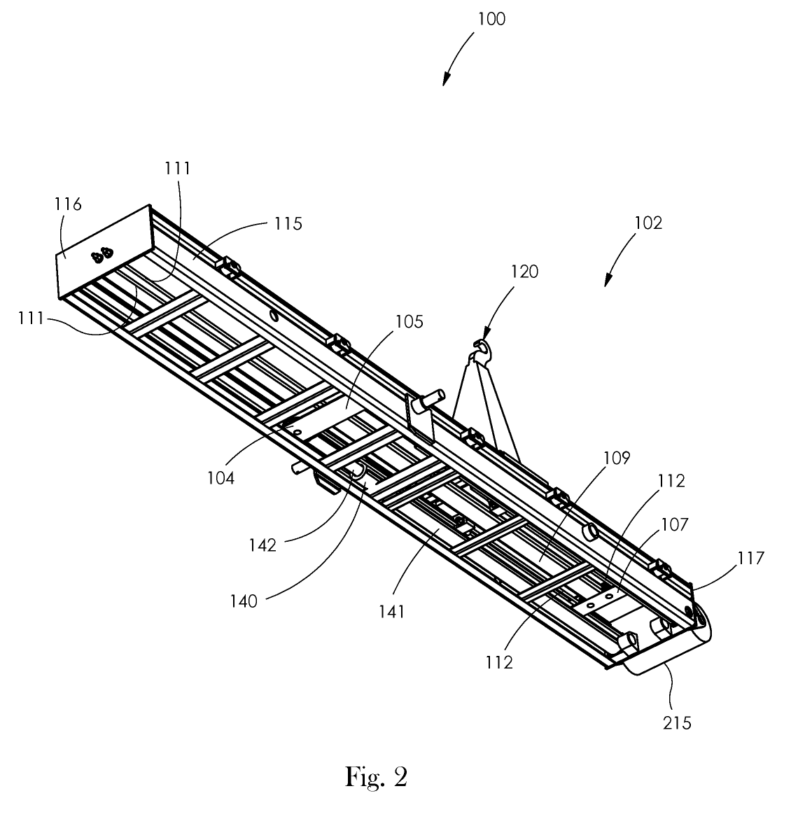

A vehicle-mounted lift 100 according to one embodiment of the present invention is depicted in FIG. 1. Vehicle-mounted lift 100 includes a frame assembly 115, an actuator (such as an extension cylinder, one example being single-stage hydraulic cylinder 140), and a carriage assembly 125, which moves along frame 115. Carriage assembly 125 is attached to a hook assembly 120, which is adapted to connect to an object to be loaded, such as a container. Hook assembly 120 and carriage assembly 125 are depicted as being located at the forward end 116 of frame assembly 115 in FIG. 1; however, a cable reeving apparatus and system 102 (see FIGS. 2-6) moves carriage assembly 125 along the length of frame assembly 115 from the forward end 116 to the rear end 117 of frame assembly 115 to load, unload and dump containers.

In FIG. 1, frame assembly 115 is attached to truck 80 by one or more lift cylinders 135 and a rear hinge assembly 200. One end of each lift cylinder 135 is pivotally connected to the frame assembly 115 and the other end of each lift cylinder 135 is pivotally connected to the frame of truck 80. The lift cylinder(s) 135 expand and contract to raise and lower the forward end 116 of frame assembly 115, which assists with the loading, unloading and dumping of containers.

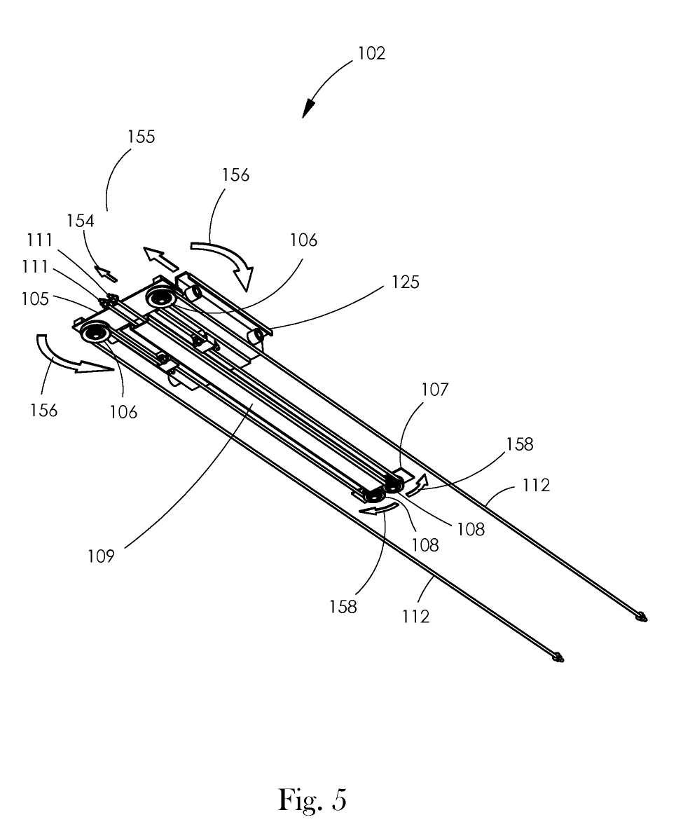

Depicted in FIGS. 2-6 are views of vehicle-mounted lift 100 in progressively more disassembled states to provide the reader with a depiction of the inner workings of vehicle-mounted lift 100. In FIGS. 2-4 and 6, the carriage assembly 125 is depicted as being located at approximately the same positions. However, in FIG. 5 the carriage assembly 125 is located in a position different from those depicted in FIGS. 2-4 and 6 to illustrate how various components of vehicle-mounted lift 100 interact as the carriage assembly 125 moves.

Cable reeving system 102 includes an actuator (for example, single-stage hydraulic cylinder 140) that is attached to frame 115 and applies force against the middle portion of a cable assembly (for example, front cable 111 or rear cable 112) to pull carriage assembly 125 along frame 115. One end of each cable is attached to the frame 115 and the other end of each cable is attached to carriage assembly 125.

Cables, as used herein, are intended to mean and include elongated load-bearing members (such as wire ropes, chains and non-wire ropes) that are sufficiently flexible to be disposed around and operate in conjunction with one or more pulleys or bearing members while being sufficiently strong to pull a desired load.

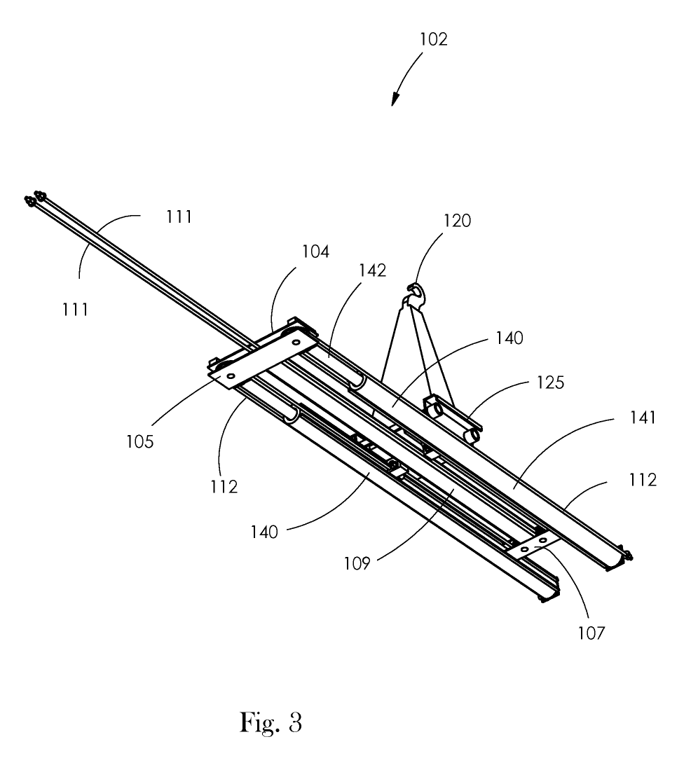

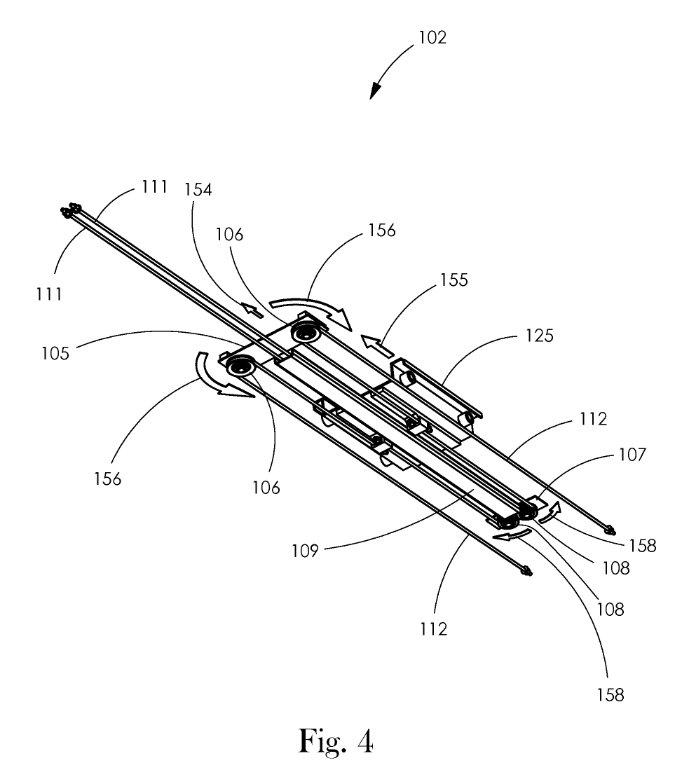

Hydraulic cylinder 140 is connected to and utilizes a traveler assembly 104 to apply forces to the cables. Traveler assembly 104 is supported by frame assembly 115, and travels forward and backward relative to frame assembly 115. Referring to FIGS. 3 and 4, traveler assembly 104 includes a front assembly 105 connected to a rear assembly 107 by a spacing member 109. Front cables 111 are attached to the forward end 116 of frame assembly 115, disposed around rear cable engaging members on rear assembly 107 (for example, rear pulleys 108) changing direction 180 degrees, and attached to carriage assembly 125. Rear cables 112 are attached to the rear end 117 of frame assembly 115, disposed around forward cable engaging members on front assembly 105 (for example, forward pulleys 106) changing direction 180 degrees, and attached to carriage assembly 125. Additionally, each cable engaging member includes one or more cable bearing surfaces that contact the cable disposed around the engaging member.

Carriage assembly 125 (and hook assembly 120) move the full length of the frame assembly 115 in response to hydraulic cylinder(s) 140 moving traveler assembly 104 forward and backward along frame 115. Front cables 111 and rear cables 112 remain taut and engaged with pulleys 108 and 106 irrespective of the movement of traveler assembly 104.

In use, hydraulic cylinders 140 (each of which includes piston cylinder 141 and piston rod 142, see FIGS. 2 and 3), push and pull traveler assembly 104 forward and backward with respect to frame assembly 115. The forward movement of traveler assembly 104 generally results in forward pulleys 106 actively pressing (and rotating) against rear cables 112. In response, rear cables 112 pull in the same direction (toward the front end 116 of frame 115) against frame 115 and carriage 125, which causes carriage 125 to travel forward with respect to frame 115. Similarly, the rearward movement of traveler assembly 104 generally results in rear pulleys 108 actively pressing (and rotating) against front cables 111. In response, front cables 111 pull in the same direction (toward the rear end 117 of frame 115) against frame 115 and carriage 125, which causes carriage 125 to travel rearward with respect to frame 115. As a result, the forward movement of traveler assembly 104 results in forward movement of carriage assembly 125 and rearward movement of traveler assembly 104 results in rearward movement of carriage assembly 125. Preferably, there is minimal friction associated with the rotation of pulleys 106 and 108, resulting in the forces applied to frame 115 and carriage 125 by cables 111 and 112 being approximately equal.

As depicted in FIG. 4, movement of traveler assembly 104 in direction 154 (toward forward end 116 of frame 115) results in forward pulley 106 rotating in direction 156 and rear pulleys 108 rotating in directions 158. As a result, carriage assembly 125 is pulled in direction 155 and at a rate that is greater than the rate at which traveler assembly 104 is pushed in direction 154 by hydraulic cylinders 140, which is approximately twice the rate that traveler assembly 104 is pushed in the example embodiment. Stated differently, when traveler assembly 104 is pushed by cylinder 140 in direction 154 a particular distance, carriage assembly 125 is pulled by front cable 111 in direction 155 (which is parallel to direction 154) a multiple of the distance that traveler assembly 104 moved, which is approximately twice the distance that traveler assembly 104 is moved in the illustrated embodiment. FIG. 5 depicts the locations of traveler assembly 104 and carriage assembly 125 after traveler assembly 104 has been moved a distance in direction 154.

The movement of traveler assembly 104 in direction 154 results in rear cables 112 (which are disposed around forward pulleys 106) being the active cables pulling carriage assembly 125 in direction 155 and performing at least a majority, if not all, of the work to move carriage assembly 125 along frame 115. Conversely, when traveler assembly 104 is moved opposite to direction 154, front cables 111 (which are disposed around rear pulleys 108) are the active cables pulling carriage assembly 125 opposite to direction 155 and performing at least a majority, if not all, of the work to move carriage assembly 125 along frame 115 and opposite to direction 155.

If the forward end 116 of frame assembly 115 is raised (thereby raising forward pulleys 106 above rear pulleys 108), rear cables 112 and forward pulleys 106 become active to prevent carriage assembly 125 from moving rearward. In this example, moving carriage assembly 125 rearward is accomplished, at least in part, by allowing gravity to pull carriage assembly 125 opposite to direction 155 while rear cables 112 acting via forward pulleys 106 control the rate at which carriage assembly moves toward the rear end 117 of frame 115.

Hydraulic cylinder 104, as depicted in FIG. 2, is preferably a single-stage hydraulic cylinder with a single piston rod 142 moving in relation to a single piston cylinder 141. In contrast, multi-stage hydraulic cylinders include at least three telescoping members—a piston rod, a piston, and at least one hybrid-piston disposed between the piston and piston rod which functions like a piston with respect to the piston rod and functions like a piston rod with respect to the piston. As measured along the length of frame 115, single-stage hydraulic piston cylinder 141 is considerably longer than the hook assembly 120 and carriage assembly 125. Without cable reeving system 102 and with carriage assembly 125 directly attached to piston rod 142, carriage assembly 125 would move at most the length of piston rod 142 as piston rod 142 moves between its fully-extended position to its fully-retracted position and carriage assembly 125 would be incapable of moving to locations adjacent piston 141. However, with cable reeving system 102, carriage assembly 125 can be moved to locations adjacent piston 141 and can be moved from the forward end 116 of frame assembly 115 to the rear end 117 of frame assembly 115 without requiring the use of multi-staged hydraulic cylinders.

Since the front 111 and rear 112 cables are each disposed around a single pulley and the overall length of front 111 and rear 112 cables are kept to a minimum, the total number of pulleys is minimized, the overall complexity of the cable reeving system is minimized, and the free-play and bounce that can occur with longer cables (especially when disposed around multiple pulleys) is also minimized.

Although cable reeving system 102 is depicted in FIGS. 2-6 as including four separate cables (two front cables 111 and two rear cables 112) and four pulleys (two forward pulleys 106 and two rear pulleys 108), alternate embodiments include a different number of cables and pulleys. For example, one embodiment may use a single front cable disposed around a single rear pulley, and a single rear cable disposed around a single forward pulley, thereby eliminating two cables and two pulleys from the embodiment depicted in FIGS. 2-6. Other embodiments may use three or more front cables, each disposed around a rear pulley, and three or more rear cables, each disposed around a forward pulley. The maximum force that can be generated for loading, dumping and/or unloading a container depends, at least in part, on the strength of the individual cables and pulleys as well as the total number of cables and pulleys used.

In still further embodiments, a long single cable with a length approximately equal to the combined lengths of a front cable 111 and a rear cable 112 is used in place of a front 111 and rear 112 cable pair. In these embodiments, one end of the single cable is attached to the rear end 117 of frame assembly 115 and the other end of the single cable is attached to the forward end 116 of frame assembly 115 with the single cable being disposed around both a forward pulley 106 and a rear pulley 108. A portion of the single cable disposed between forward pulley 106 and rear pulley 108 is attached to carriage assembly 125 to move carriage assembly 125 in the forward and rearward directions. (It should be appreciated that if the single cable in these embodiments were bisected at a location where the single cable attaches to carriage assembly 125 and the two additional ends of the cable created by the bisection were each attached to carriage assembly 125, an embodiment similar to that depicted in FIGS. 2-6 would result). In these embodiments, when the traveler assembly 104 is moved in the forward direction (similar to direction 154 depicted in FIG. 4), the active portion of the single cable (the portion performing a majority of the work to pull carriage assembly 125) is disposed around the active forward pulley 106. Conversely, when the traveler assembly 104 is moved toward the rear end 117 of frame assembly 115 (in the direction opposite to direction 154 depicted in FIG. 4), the active portion of the single cable is disposed around the active rear pulley 108 to pull the carriage assembly 125 rearward. Since the active portions of the single cable are disposed around a single pulley, as opposed to multiple pulleys, the length of the active portion is kept to a minimum and the number of active pulleys is kept to a minimum, thereby decreasing excess friction, play and bounce in the system.

Additionally, although the figures depict the cable reeving system actuators (hydraulic cylinders 140) as being attached to the rear end 117 of frame 115, it should be appreciated that one or more actuators may be attached to any location where the actuators can move traveler assembly 104 forward and/or rearward relative to frame 115. For example, the actuators may be connected to the forward end 116 of frame 115. The actuators may also be connected to the sides of frame 115, such as when traveler assembly 104 includes a toothed bar (rack) and the actuator includes a toothed gear (pinion) that engages and applies force to the toothed bar.

Moreover, while the actuators associated with cable reeving system 102 are depicted as being single-stage hydraulic cylinders, it should be appreciated that other forms of actuators may be utilized. For example, multi-stage hydraulic cylinders may be utilized, although some advantages associated with using single-stage cylinders instead of multi-stage cylinders would generally not be realized in these embodiments. As another example, rack and pinion or jack screw type actuators may also be utilized.

The rear end 117 of frame 115 is attached to the vehicle with hinge assembly 200, which uses multiple pivot points and includes one or more forward links 203 and one or more rear links 205. One end of each forward link 203 and one end of each rear link 205 is pivotally connected to the frame assembly 115. The other end of each forward link 203 and each rear link 205 is pivotally connected to the frame of truck 80.

With the frame in the stowed position, the forward 203 and rear 205 links form a V-type configuration with each link angling upward and away from the other link, but with the lower ends of the links being separated. Attached to the rear portion of the tiltable frame is a stabilizer, which in one variation is a roller.

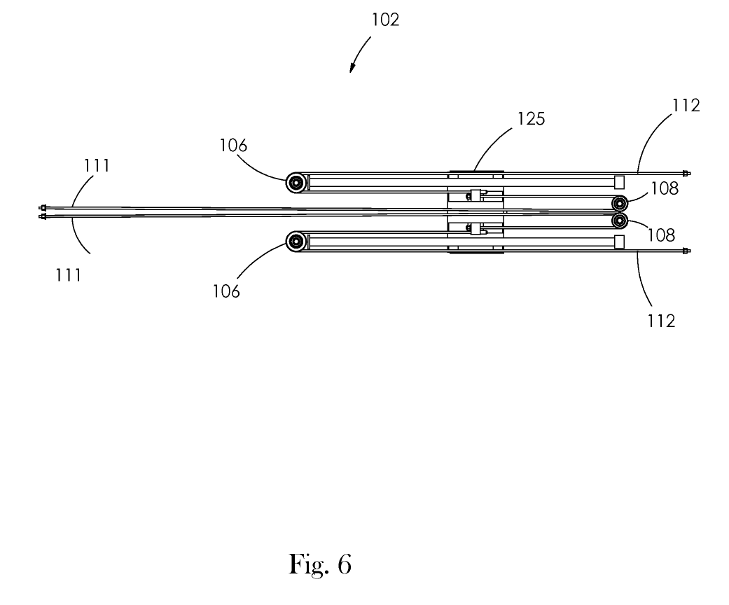

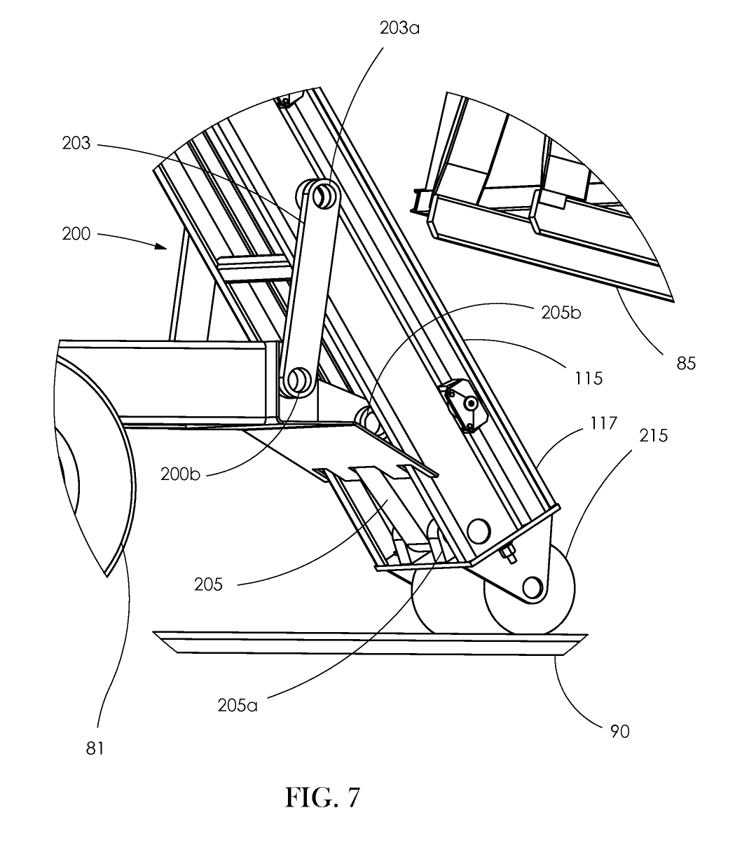

Depicted in FIG. 7 is a fragmentary, perspective view of rear hinge assembly 200, stabilizer 215, and the rear portions of frame assembly 115 and truck 80. (Wheel 81 of truck 80 is depicted as being separated from rear hinge assembly 200 by a greater distance in FIG. 6 than in FIGS. 1 and 8-11 to provide a clearer view of rear hinge assembly 200). (The rear bumper of truck 80 is also not depicted in FIG. 6 to provide a clearer view of the rear hinge assembly 200). In FIG. 7, container 85 is depicted as being connected to hook assembly 120, with the front end of container 85 being lifted off of support surface 90 as container 85 is loaded by vehicle-mounted lift 100 onto truck 80.

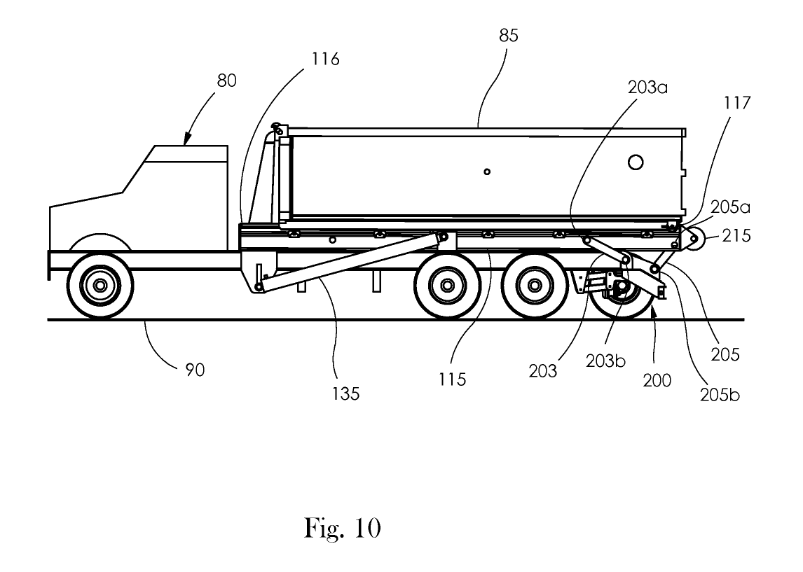

As depicted in FIGS. 7 and 10, forward link 203 is pivotally attached to frame assembly 115 at location 203a, which is forward of location 205a at which rear link 205 is pivotally attached to frame assembly 115. The location 203b at which forward link 203 is pivotally attached to the frame of truck 80 is also forward of the location 205b at which rear link 205 is pivotally attached to the frame of truck 80. With the forward end 116 of frame assembly 115 in the lowered position (see FIGS. 1 and 10), forward link 203 angles upward toward the forward end of truck 80 and toward the forward end 116 of frame assembly 115 while rear link 205 angles upward toward the rear end 117 of frame assembly 115. In other words, the attachment location 203a between forward link 203 and frame assembly 115 is forward of and above the attachment location 203b between forward link 203 and the truck frame while the attachment location 205a between rear link 205 and frame assembly 115 is aft of and above the attachment location 205b between rear link 205 and the truck frame.

The attachment location 203b between forward link 203 and the frame of truck 80 is also forward of and above the attachment location 205b between rear link 205 and the truck frame. Still further, the distance between the locations at which rear hinge assembly 200 attaches to frame 115 (the distance between attachment locations 203a and 205a) is greater than the distance between locations at which rear hinge assembly 200 attaches to the frame of truck 80 (the distance between attachment locations 203b and 205b). Moreover, the effective length of forward link 203 (the distance between attachment locations 203a and 203b) is also longer than the effective length of rear link 205 (the distance between attachment locations 205a and 205b) in the illustrated embodiment.

When lift cylinder(s) 135 extend and the forward end 116 of frame assembly 115 is raised, the rear portion 117 of frame assembly 115 begins moving rearward and downward due to the arrangement of rear-hinge assembly 200. When the forward end 116 of frame assembly is raised sufficiently, stabilizer 215 (depicted as a roller attached to the rear end 117 of frame 115) contacts the support surface 90 (e.g., pavement). The contact between stabilizer 215 and the support surface 90 increases the stability of truck 80 and maintains the front end of the truck 80 on the support surface 90 as container 85 is loaded and/or unloaded.

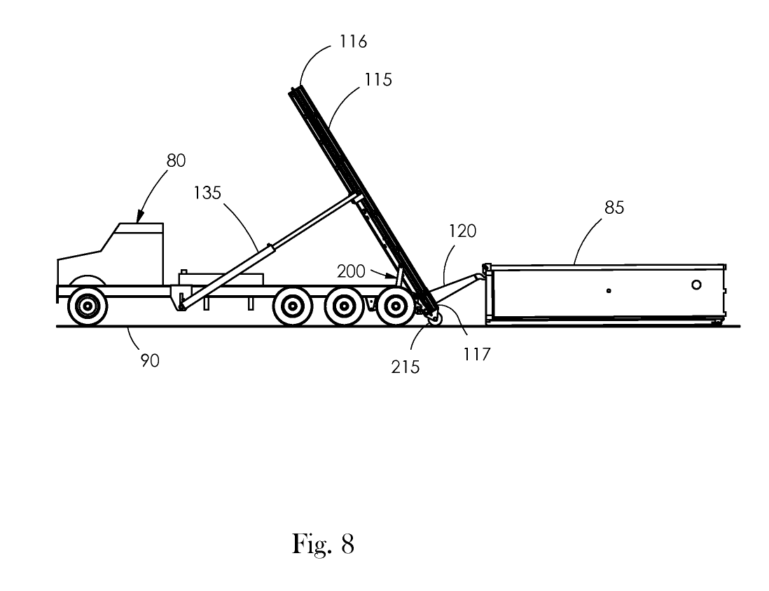

The loading and dumping of a container 85 according to one embodiment of the present invention is depicted in FIGS. 8-11. Unloading container 85 is accomplished in roughly the reverse sequence to loading container 85 as would be understood by one of ordinary skill in the art. To load container 85, the operator positions truck 80 near the forward end of container 85. The operator extends lift cylinder(s) 135 and raises the forward end 116 of frame assembly 115. As the forward end 116 of frame assembly 115 is raised, the rear end 117 of frame 115 rotates and extends downward. The operator also retracts the cable reeving actuators (hydraulic cylinders 140, see FIGS. 2 and 3) and moves the carriage 125 and hook assembly 120 (at a faster speed than the actuator(s) retract) to the rear end 117 of frame assembly 115. The operator will typically back truck 80 toward container 85 placing hook assembly 120 under a portion of container 85 adapted to connect with hook assembly 120.

If stabilizer 215 has been placed in contact with the support surface prior to the operator backing truck 80 up to container 85, the round cylindrical shape of stabilizer 215 and its ability to rotate about its longitudinal axis decreases wear and tear on the stabilizer 215, the rear end of frame 117, the rear hinge assembly 200, and truck 80, and facilitates the placement of hook assembly 120 in contact with container 85. Additionally, the preferably open (see-through or non-enclosed) nature of vehicle-mounted lift 100 allows the operator to view container 85 through frame assembly 115, enhancing the operator's ability to appropriately position hook assembly 120 with respect to container 85.

Once hook assembly 120 is appropriately positioned to engage container 85, the operator extends the cable reeving actuators (cylinders 140, see FIGS. 2 and 3) and begins moving hook assembly 120 from the rear end 117 of frame assembly 115 toward the forward end 116 of frame assembly 115. As hook assembly 120 is pulled toward the forward end 116 of frame assembly 115, container 85 is pulled onto frame assembly 115.

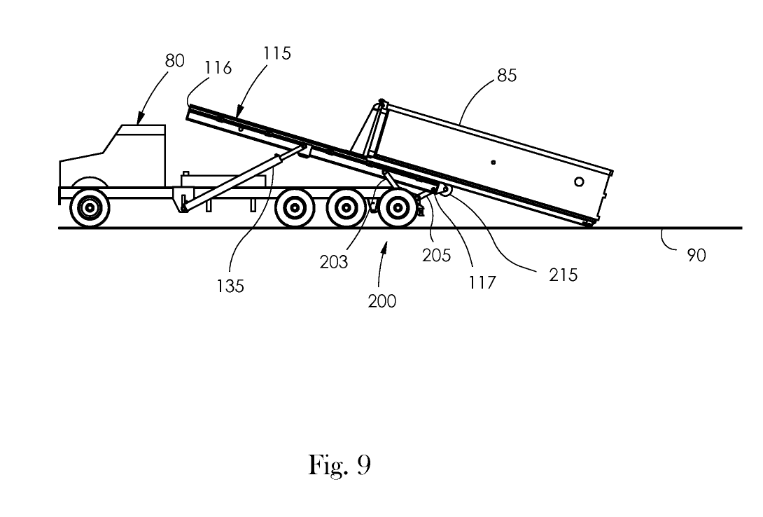

Once container 85 reaches a location where the forward end 116 of frame assembly 115 can be lowered, the operator will frequently retract lift cylinders 135 to decrease the incline up which container 85 is pulled and, thereby, decrease the force required to continue moving hook assembly 120 and container 85 toward the forward end 116 of frame assembly 115. FIG. 9 depicts a point during the loading of container 85 at which the forward end 116 of frame assembly 115 has been lowered to decrease the force required to pull container 85 onto frame 115.

Once container 85 has been pulled a sufficient distance onto frame assembly 115, the operator retracts lift cylinder(s) 135 to fully lower frame assembly 115 onto truck 80 (see FIG. 10). The container is generally considered fully loaded onto truck 80 with the frame assembly 115 in the fully lowered position and the hook assembly 120 adjacent the forward end 116 of frame assembly 115. Since the center of gravity of cable reeving system 110 and the loaded container 85 are at their lowest position, with the forward end 116 of frame assembly 115 fully lowered this arrangement is typically used during transport of container 85.

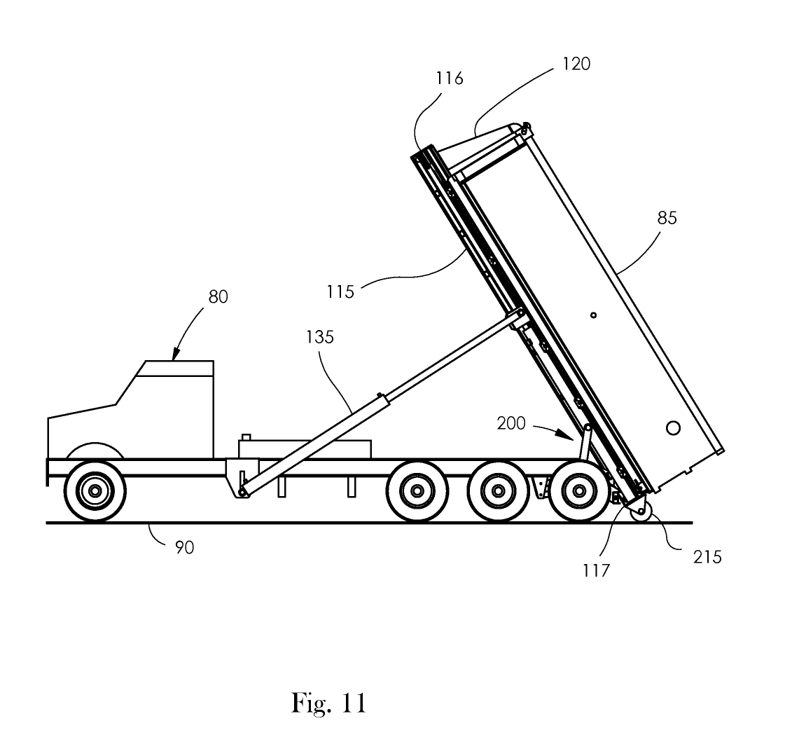

To dump a payload of material located within container 85, the operator maintains hook assembly 120 at the forward end 116 of frame assembly 115 and extends lift cylinder(s) 135 (see FIG. 11). As lift cylinder(s) 135 extend, the forward end 116 of frame assembly 115 and the forward end of the container 85 are raised upward to allow the contents of container 85 to slide out the rear end of container 85 by gravity. As seen in FIG. 11, with the forward end 116 of frame assembly 115 in the fully-raised position, stabilizer 215 is in contact with support surface 90, which enhances the stability of truck 80 and helps maintain the forward end of truck 80 on the support surface.

Although the above description refers to containers being loaded, unloaded and tilted/dumped by the vehicle-mounted lift, the term “container” is not intended to be limiting and other objects that may or may not meet the definition of a container are contemplated as being loaded, unloaded and tilted/dumped by the disclosed vehicle-mounted lift.

Moreover, although the front and rear cable engaging members of traveler assembly 104 are depicted as being pulleys, for example forward pulleys 106 and rear pulleys 108, other embodiments of the present invention utilize alternate mechanisms for engaging the flexible members (cables) that are connected to frame 115 and carriage assembly 125. For example, alternate embodiments use toothed and/or non-toothed gears engaging chains, while still other embodiments use low friction bearing surfaces or couplings such as one or more curved members coated with a low friction lubricant or compound (for example, Delrin® manufactured by DuPont E I de Nemours & Co.) to apply force to an intermediate portion of the cable/rope/chain that is connected to the carriage assembly.

Furthermore, although carriage assembly 125 is depicted as using rollers or wheels to decrease the friction between carriage 125 and frame 115, it should be appreciated that other means of reducing the friction between carriage 125 and frame 115 may be used. For example, low friction coatings such as Delrin® or various types of lubricants may be used to decrease the friction between carriage 125 and frame 115 as carriage 125 slides along frame 115.

Furthermore, although the lift cylinders and actuators described herein are generally described as being hydraulic cylinders, other types of force generating members may be used provided sufficient force can be applied to accomplish the desired task. For example, electrically powered actuators, pneumatically powered actuators, and other types of actuators, such as those utilizing jack screws, may be used.

While illustrated examples, representative embodiments and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. Dimensions, whether used explicitly or implicitly, are not intended to be limiting and may be altered as would be understood by one of ordinary skill in the art. Exemplary embodiments have been shown and described, and all changes and modifications that come within the spirit of the invention are desired to be protected.

What is claimed is:

1. A vehicle-mounted lift system, comprising:
a frame adapted to connect to a vehicle, the frame including first and second opposing ends defining a length;
a carriage connected to the frame and movable between the first and second opposing ends, the carriage adapted to connect to a container to move the container onto the vehicle to which the frame is connected;
a traveler assembly with first and second bearing surfaces, the traveler assembly being movable along the length of the frame; and
a cable arrangement attached to the first and second opposing ends of the frame and to the carriage, the cable arrangement extending from the first opposing end of the frame to the carriage and to the second opposing end of the frame;
wherein a portion of the cable arrangement between the first opposing end of the frame and the carriage bends around the first bearing surface, and a portion of the cable arrangement between the second opposing end of the frame and the carriage bends around the second bearing surface; and
wherein movement of the traveler assembly toward the first opposing end of the frame causes the cable arrangement to move the carriage toward the first opposing end of the frame a greater distance than the traveler assembly moves.

2. The vehicle-mounted lift system of claim 1, wherein movement of the traveler assembly toward the second opposing end of the frame causes the cable arrangement to move the carriage toward the second opposing end of the frame a greater distance than the traveler assembly moves.

3. The vehicle-mounted lift system of claim 1, wherein the first bearing surface is located on a first pulley and the second bearing surface is located on a second pulley.

4. The vehicle-mounted lift system of claim 1, wherein the cable arrangement includes two cables, one end of each cable connected to the frame and the other end of each cable connected to the carriage.

5. The vehicle-mounted lift system of claim 1, wherein movement of the traveler assembly toward the first opposing end of the frame causes the cable arrangement to pull the carriage toward the first opposing end of the frame.

6. The vehicle-mounted lift system of claim 5, wherein movement of the traveler assembly toward the second opposing end of the frame causes the cable arrangement to pull the carriage toward the second opposing end of the frame.

7. The vehicle-mounted lift system of claim 6, wherein movement of the traveler assembly toward the first opposing end of the frame causes the cable arrangement to move the carriage toward the first opposing end of the frame, the carriage moving a distance approximately twice the distance the traveler assembly moves.

8. The vehicle-mounted lift system of claim 1, wherein the first and second bearing surfaces are separated from one another by a fixed nonzero distance along the length of the frame.

9. The vehicle-mounted lift system of claim 1, wherein the cable arrangement bends approximately one hundred eighty degrees (180°) around the first bearing surface and bends approximately one hundred eighty degrees (180°) around the second bearing surface.

10. The vehicle-mounted lift system of claim 1, wherein the frame is adapted to tilt with respect to the vehicle to which it is connected.

11. The vehicle-mounted lift system of claim 1, comprising:
an extension cylinder attached to the traveler assembly and the frame, wherein extension and retraction of the extension cylinder causes a corresponding movement of the carriage between the first and second opposing ends.

12. The vehicle-mounted lift system of claim 11, wherein the extension cylinder is a single-stage cylinder.

13. A vehicle-mounted lift system, comprising:
a frame adapted to connect to a vehicle, the frame including first and second opposing ends defining a length;
a carriage connected to the frame and movable between the first and second opposing ends, the carriage adapted to connect to a container to move the container onto the vehicle to which the frame is connected; and
a cable arrangement attached to and extending between the frame and the carriage, a portion of the cable arrangement between the frame and the carriage bending around a bearing surface, the bearing surface being drivable by a mechanism to translate the bearing surface toward the first opposing end of the frame and press the bearing surface against the cable arrangement causing the carriage to move toward the first opposing end of the frame.

14. The vehicle-mounted lift system of claim 13, wherein movement of the bearing surface toward the first opposing end of the frame causes the carriage to move toward the first opposing end of the frame a distance approximately twice the distance the bearing surface moves.

15. The vehicle-mounted lift system of claim 13, comprising:
an extension cylinder attached to the bearing surface and the frame, wherein extension and retraction of the extension cylinder causes a corresponding movement of the carriage between the first and second opposing ends.

16. The vehicle-mounted lift system of claim 15, wherein the extension cylinder is a single-stage cylinder.

17. A vehicle-mounted lift system, comprising:
a frame adapted to connect to a vehicle, the frame including first and second opposing ends;
a carriage connected to the frame and movable between the first and second opposing ends, the carriage adapted to connect to a container to move the container onto the vehicle to which the frame is connected; and
a cable arrangement attached to and extending between the frame and the carriage, a portion of the cable arrangement between the frame and the carriage bending around a first bearing surface, the first bearing surface being drivable by a translation mechanism to press the first bearing surface against the cable arrangement and cause the cable arrangement to pull the carriage a distance approximately twice the distance the first bearing surface is moved by the translation mechanism.

18. The vehicle-mounted lift system of claim 17, wherein movement of the translation mechanism toward one of the opposing ends of the frame causes the cable arrangement to pull the carriage toward the same opposing end.

19. The vehicle-mounted lift system of claim 17, wherein the cable arrangement includes first and second cables,
the first cable bending around the first bearing surface and being attached to the first opposing end of the frame and to the carriage, the first bearing surface being drivable by the translation mechanism to press the first bearing surface against the first cable and cause the first cable to pull the carriage toward the first opposing end of the frame,
the second cable bending around a second bearing surface and being attached to the second opposing end of the frame and to the carriage, the second bearing surface being drivable by the translation mechanism to press the second bearing surface against the second cable and cause the second cable to pull the carriage toward the second opposing end of the frame a distance approximately twice the distance the second bearing surface is moved by the translation mechanism.

20. The vehicle-mounted lift system of claim 17, wherein the first bearing surface is disposed on a pulley.
